(19) United States
(12) Patent Application Publication
(10) Pub. No.: US 2005/0031941 A1
(43) Pub. Date: Feb. 10, 2005

(54) Explosion-proof separator for Li-ion secondary batteries

(75) Inventors: Zhengming Zhang, Charlotte, NC (US); Donald K. Simmons, Charlotte, NC (US); Kevin D. Chambers, Fort Mill, SC (US); Pankaj Arora, Charlotte, NC (US)

Correspondence Address: ROBERT H. HAMMER III, P.C., 3121 SPRINGBANK LANE, SUITE I, CHARLOTTE, NC, 28226, US

(73) Assignee: Celgard Inc.

(21) Appl. No.: 10/624,277

(22) Filed: Jul. 22, 2003

Related U.S. Application Data
(63) Continuation-in-part of application No. 10/286,544, filed on Nov. 1, 2002, now abandoned.

(51) Int. Cl. H01M 2/16

(52) U.S. Cl. 429/142; 429/61; 429/248

(57) ABSTRACT

A battery separator for a lithium-ion secondary battery is a microporbus membrane with an adjuvant. The microporous membrane is made of a thermoplastic, and has a thickness of 25 μm or less. The adjuvant, in an effective amount, is mixed into the membrane or coated thereon. The adjuvant is a material adapted to reduce or eliminate energy concentrations around the separator. The energy concentration is sufficient to initiate a reaction of the components of the lithium ion secondary battery.

### RELATED APPLICATION

This application is a continuation-in-part of co-pending application Ser. No. 10/286,544 filed Nov. 1, 2002.

### FIELD OF THE INVENTION

The instant invention is a battery separator for a lithium ion (Li-ion) secondary battery.

### BACKGROUND OF THE INVENTION

A Li-ion secondary battery is a cylindrical or prismatic battery having a rigid (e.g., metallic) can and a liquid electrolyte. Today, these types of batteries are used in portable phones, computers, video cameras, still cameras, and are used in larger systems, such as automobiles.

Such batteries are subject to a phenomenon known as “thermal runaway.” Thermal runaway is the unwanted and uncontrolled generation of heat within the battery. Thermal runaway in a battery most often leads to battery failure. Thermal runaway in a battery contained within rigid can, if unchecked, can, in limited instances, lead to can rupture and catastrophic failure of the battery; that is an explosion or fire.

Upon closer examination of the thermal runaway phenomenon, it can be categorized into two areas: sudden (or rapid) thermal runaway, and delayed thermal runaway. These two types of runaway are differentiated by the rate of heat generation. In the sudden thermal runaway situation, the maximum temperature is obtained in less than about 1-3 seconds. In the delayed thermal runaway situation, the maximum temperature is obtained in a longer period of time, for example, in greater than 30 seconds. These runaway phenomenons are observed in nail penetration tests, bar crush tests, cycling tests, and external shorting tests. A localized heat increase due to non-uniform current or due to some highly reactive species can quickly initiate sudden thermal runaway reactions. A more uniform distribution of current and heat will require longer times to reach the high temperatures needed for delayed thermal runaway. In general, but not always, sudden thermal runaway is most often seen with internal shorting tests (e.g., nail penetration and bar crush tests), while delayed thermal runaway is most often seen with the external shorting tests. In general, but not always, sudden thermal runaway is most closely associated with catastrophic failure of the battery.

Currently, Li-ion secondary batteries have several features which are intended to guard against the thermal runaway phenomenon. None of these features provide an absolute defense against thermal runaway, but they do limit its occurrence. Those features include: a rupture valve on the can, Current Interrupt Device (CID), Pressure Temperature Coefficient device (PTC), electronic circuitry, and shutdown separators. CID is usually pressure activated on overcharge and permanently opens the electrical connection. PTC is usually built into the header of a cylindrical cell. It is used to limit currents in an overcharge condition (tripped by heat) and to limit short circuit currents from a single cell to a safe level. The shutdown separator is typically a microporous membrane that is sandwiched between the anode and the cathode and that contains the electrolyte, the liquid by which ions are conducted between the electrodes. These separators are designed to “shut down,” i.e., stop, or significantly reduce ion flow between the electrodes prior to reaching the maximum temperature, and thereby arrest the thermal runaway.

Shutdown separators designed to obtain the foregoing operating objective are typically constructed from polyethylene (PE). PE is the material of choice because its melting temperature (about 130° C.) is below the ignition temperature of Li (about 160° C.). Moreover, these separators are either single layered or multi-layered (e.g., tri-layer) structures. In the tri-layered structure, the inner layer is most often the PE layer. In operation, as the temperature within the battery increases and reaches the melting temperature of PE layer, the PE melts closing the pores and causing the ionic resistivity of the separator to increase, but the separator retains sufficient structural integrity to keep the electrodes from coming into contact. This operation has worked very well to reduce the adverse consequences arising from the delayed thermal runaway; but this operation has not worked as well against the sudden thermal runaway.

Further study of the sudden thermal runaway phenomenon has led to the following hypotheses: 1) an electric spark (e.g., ionizing materials) is created and jumps between the electrodes when they are brought close together; and 2) a localized hot spot is created. The spark and/or the hot spot are of sufficient energy density to initiate a reaction between the materials of the battery (e.g., lithiated carbon of the anode, the transition metal oxides (e.g., LiₓCoO₂, LiₓNiO₂, LiₓMn₂O₄) of the cathode, the organic liquid of the electrolyte, and the polyolefins of the separator). Once the reaction starts, evolution of heat is rapid.

Accordingly, there is a need for new battery separators for Li-ion batteries that reduce or eliminate the adverse consequences of thermal runaway, particularly the phenomenon of sudden thermal runaway.

U.S. Pat. No. 6,171,689 discloses a flame retardant microporous material that is useful in clothing, wall or roof barriers, optical films in optical devices (such as light reflective and dispersive films), printing substrates, and electrical insulations. The disclosure membranes, having a minimum thickness of 33 μm, are too thick to be suitable separators for Li-ion secondary batteries.

### SUMMARY OF THE INVENTION

A battery separator for a lithium-ion secondary battery is a microporous membrane with an adjuvant. The microporous membrane is made of a thermoplastic, and has a thickness of 25 μm or less. The adjuvant, in an effective amount, is mixed into the membrane or coated thereon. The adjuvant is a material adapted to reduce or eliminate energy concentrations around the separator. The energy concentration is sufficient to initiate a reaction between the components of the lithium ion secondary battery.

### DETAILED DESCRIPTION OF THE INVENTION

A lithium ion secondary battery is a cylindrical or prismatic battery composed of anode, cathode, separator, and electrolyte, which is packaged in a rigid (e.g., metallic) can or flexible foil.

A battery separator for a lithium-ion secondary battery is a microporous membrane with an adjuvant. The microporous membrane is a thermoplastic membrane film. The thermoplastics include, but are not limited to, polyvinyl chlorides, nylons, fluorocarbons, polyolefins, and polyesters. Polyolefins include, but are not limited to, polyethylenes, polypropylenes, polybutylenes, and polymethyl pentenes. Most preferably, the polyolefin is polyethylene or copolymers of polyethylene (including ultrahigh molecular weight polyethylene). The adjuvant, in an effective amount, is mixed into the separator or coated thereon. The adjuvant is a material adapted to reduce or eliminate energy concentrations around the separator. The energy concentration is sufficient to initiate a reaction between the components of the lithium ion secondary battery.

The foregoing separator may be embodied in several different ways. They include: a self-quenching or fire retardant separator; a conductive separator; and a self-extinguishing separator. Each of these will be discussed in further detail below. But, in each a conventional Li-ion separator, i.e., a microporous membrane, has an adjuvant either mixed into, e.g., physically blended with the polymer, or chemically grafted onto the polymer, or coated onto the membrane.

Such microporous membranes are well known and commercially available from Celgard Inc. of Charlotte, N.C., USA (CELGARD® membranes, single layer and tri-layer membranes); Tonen Chemical Co. of Tokyo, Japan; Asahi Kasei of Tokyo, Japan (HIPORE™), and Ube Industries of Tokyo, Japan (U-PORE™). These membranes may be made by the “dry-stretch” (or Celgard) process or the “wet” (or phase inversion) process, or by a particle stretch process. The aforementioned microporous membranes possess a thickness of 25 μm or less; porosity range of 30% to 60%; and pore size range of (0.02 μm×0.08 μm) to (0.2 μm×1.5 μm).

The self-quenching or fire retardant separator operates on a principle where initiation of a reaction is suppressed. For example, if a spark is formed, the adjuvant reacts to the spark by quenching the spark or retarding its ability to ignite surrounding materials. Several adjuvants may be used to form this separator. They include, for example, phosphates, halogenated compounds (such as halogenated polyethylene wax), and newer non-halogenated, non-phosphate fire retardants, such as triazine derivatives. Also see: U.S. Pat. No. 6,171,689, column 5, line 55-column 7, line 58 for additional flame retardant materials, incorporated herein by reference. These materials may be used separately or in combination.

Phosphates, which are known fire retardants, may be thinly coated on the surface of the membrane or mixed with the polymer forming the membrane. One such phosphate is triphenyl phosphate. One such triphenyl phosphate is a substituted triaryl phosphate ester commercially available under the trade name PHOSFLEX® flame retardant plasticizer from Akzo-Nobel, Dobbs Ferry, N.Y., USA. Preferably, the phosphate comprises about 1-60% weight of the membrane, most preferred 1-20% weight. For example, the phosphate was coated onto the exterior surface of a microporous polyethylene membrane.

Halogenated polyethylene waxes or paraffins may be blended into the resin forming the microporous membrane, coated onto a surface of the membrane, or sandwiched between two membranes. Preferably, the halogenated wax comprises about 2-20% by weight of the membrane. The preferred halogenated wax is chlorinated polyethylene wax. Chlorinated polyethylene waxes are commercially available under the trade name TYRIN® from Dupont-Dow Elastomers LLC of Wilmington, Del., USA. For example, a blend of chlorinated polyethylene wax and polyethylene resin 2% weight wax forms a layer between two microporous polypropylene membranes. In another example, a microporous polyethylene membrane containing polyvinylidene fluoride (PVDF) is coated with chlorinated polyethylene wax.

The newer non-halogenated, non-phosphate fire retardants, such as triazine derivatives, may be blended into the resin forming the microporous membrane, coated onto a surface of the membrane, or sandwiched between two membranes. One such triazine derivative is FLAMESTAB® commercially available from Ciba Specialty Chemical Corporation, Basel, Switzerland. Preferably, the triazine derivative comprises about 0.5-10% weight of the membrane, most preferred about 1-3% weight.

The conductive separator operates on a principle where energy is conducted away so that no energy concentration great enough to initiate a reaction is allowed to arise. Energy referred to here means electrical energy, thermal energy, or both. For example, if a spark is formed, the adjuvant rapidly distributes the energy away so that no concentration points arise. Several adjuvants may be used to form this separator. They include, for example, inorganic materials (e.g., metals, ceramics, or semiconductors), carbon black, and organic materials. The inorganic materials may be either electrically conductive, electrically semiconductive, thermally conductive, or a combination thereof. Carbon black can be both electrically and thermally conductive. The organic materials are typically electrically conductive. The inorganic materials include, but are not limited to, Al₂O₃, SiO₂, and TiO₂. The organic materials include, but are not limited to, polyaniline and polyacetylene. These materials may be used separately or in combination.

The inorganic materials and carbon black may be blended into the resin forming the microporous membrane, coated onto a surface of the membrane, or sandwiched between two membranes. These materials may comprise about 1-40% weight of the membrane, preferably about 1-20% weight and most preferably 1-10% weight. For example, 2% weight TiO₂ can be blended with a polyethylene resin that was subsequently formed into a layer between two microporous polypropylene membranes. In another example, 30% weight carbon black is dispersed into PVDF that was subsequently formed into a layer sandwiched between microporous polypropylene membranes.

The organic materials may be blended into the resin forming the microporous membrane, coated onto a surface of the membrane, or sandwiched between two membranes. The materials include polyaniline and polyacetylene. These materials are preferably doped or chemically modified with an acid to enhance their conductivity. One such material is ORMELON®, a polyaniline commercially available from Zipperling Kessler & Co. of Ammersbek, Germany. For example, a dispersion of 0.5% weight polyaniline was coated onto a membrane.

The self-extinguishing separator operates on a principle where a spark causes the adjuvant to decompose and forms a gas that blows electrolyte (containing, for example, ethylene carbonate (EC) or propylene carbonate (PC)) away from the energy concentration and thereby prevents initiation of a reaction. Several adjuvants may be used to form this separator. They include, for example, gassing agents. Gassing agents include, for example, tetrazole-based compounds and semicarbazide-based compounds. These materials may be blended into the resins forming the microporous membrane, coated onto a surface of the membrane, or sandwiched between two membranes. These materials may comprise about 1-40% weight of the membrane, preferably about 10-30% of the membrane. One such tetrazole-based compound is 5-phenyltetrazole (5-PT) commercially available as EXPANDEX from Uniroyal Chemical Co. of Naugatuck, Conn., USA. One such semicarbazide-based compound is p-toluenesulfonyl semicarbazide (TSSC) commercially available as CELOGEN from Uniroyal Chemical Co. of Naugatuck, Conn., USA. For example, the 5-PT was mixed with PVDF to form a sandwiched layer between two microporous polypropylene layers.

The present invention may be embodied in other forms without departing from the spirit and the essential attributes thereof, and, accordingly, reference should be made to the appended claims, rather than to the foregoing specification, as indicated the scope of the invention.

1. A battery separator for a lithium-ion secondary battery comprises:
a microporous membrane, said membrane having a thickness of 25 μm or less, said membrane being made of a thermoplastic, and an effective amount of an adjuvant adapted to reduce or eliminate energy concentrations around the separator, said energy concentrations being sufficient to initiate a reaction between components of said lithium ion secondary battery, said adjuvant being mixed into said membrane or coated thereon.

2. The battery separator of claim 1 wherein said thermoplastic being polyethylene or copolymers of polyethylene.

3. The battery separator of claim 1 herein said lithium ion secondary battery components being selected from the group consisting of anode materials, cathode materials, electrolytes, and separators.

4. The battery separator of claim 1 wherein said adjuvant being adapted to quench or to retard said energy's ability to initiate a reaction between said lithium ion secondary battery components.

5. The battery separator of claim 4 wherein said adjuvant being selected from the group consisting of: phosphates, halogenated polyethylene wax, triazine derivatives, and combinations thereof.

6. The battery separator of claim 5 wherein said phosphate comprises a triphenyl phosphate.

7. The battery separator of claim 6 wherein said triphenyl phosphate being about 1-60% by weight of the membrane of a substituted triaryl phosphate.

8. The battery separator of claim 5 wherein said halogenated polyethylene wax comprises between about 2-20% by weight of said membrane.

9. The battery separator of claim 5 wherein said triazine derivative comprises between about 0.5-10% by weight of said membrane.

10. The battery separator of claim 1 wherein said adjuvant being adapted to conduct away said energy.

11. The battery separator of claim 10 wherein said adjuvant being selected from the group consisting of inorganic materials, carbon black, organic materials, and combinations thereof.

12. The battery separator of claim 11 wherein said inorganic materials being selected from the group consisting of Al₂O₃, SiO₂, TiO₂, and combinations thereof.

13. The battery separator of claim 11 wherein said inorganic material comprises about 1-40% by weight of said membrane.

14. The battery separator of claim 11 wherein said carbon black comprises about 1-40% by weight of said membrane.

15. The battery separator of claim 11 wherein said organic material being selected from the group consisting of polyaniline, polyacetylene, and combinations thereof.

16. The battery separator of claim 1 wherein said adjuvant being adapted to decompose to a gas.

17. The battery separator of claim 16 wherein said adjuvant being selected from the group consisting of tetrazole-based compounds, semicarbazide-based compounds, and combinations thereof.

18. The battery separator of claim 17 wherein said adjuvant comprises about 1-40% by weight of said membrane.

19. The battery separator of claim 20 wherein said adjuvant comprises about 10-30% by weight of said membrane.

20. The battery separator of claim 17 wherein said tetrazole-based compound being 5-phenyl tetrazole.

21. The battery separator of claim 17 wherein said semicarbazide-based compound being p-toluenesulfonyl semicarbazide.

22. A lithium ion battery having the separator according to claim 1.
